(19) United States
(12) Patent Application Publication
(10) Pub. No.: US 2011/0103811 A1
(43) Pub. Date: May 5, 2011

(54) IMAGE FORMING APPARATUS

(75) Inventor: Masayuki Tamaki, Toride-shi (JP)

(73) Assignee: CANON KABUSHIKI KAISHA, Tokyo (JP)

(21) Appl. No.: 12/916,897

(22) Filed: Nov. 1, 2010

(30) Foreign Application Priority Data
Nov. 4, 2009 (JP) 2009-253357

(51) Int. Cl. G03G 15/01

(52) U.S. Cl. 399/40

(57) ABSTRACT

An image forming apparatus includes a photosensitive member; an exposure device for exposing to light the photosensitive member to form an electrostatic latent image by using exposure image data for an output image to which an information image to be formed so as to be made difficult to be visually recognized with respect to background color has been added; developing portion for developing the electrostatic latent image with color toner into a color toner image; a transparent toner image forming portion for forming a transparent toner image located on the color image on a recording material; and an image processing portion for generating the exposure image data so that a toner amount of the information image on which the transparent toner image is superposed is less than that of the information image on which the transparent toner image is not superposed.

### FIELD OF THE INVENTION AND RELATED ART

The present invention relates to an image forming apparatus capable of outputting a transparent toner image superposed on an output image formed on a recording material. Specifically, the present invention relates to image processing for preventing an information image or a forgery-preventing image to be formed on the recording material in an inconspicuous manner from being conspicuous due to superposition of the transparent toner image on the information image or the forgery-preventing image.

The image forming apparatus for forming a full-color image by superposing a plurality of toner images different in development color has been used widely. Further, in order to uniformize a difference in glossiness of an entire image by superposing the transparent toner image on the full-color image, a full-color image forming apparatus including a transparent image forming portion for forming the transparent toner image has also been put into practical use (Japanese Laid-Open Patent Application (JP-A) Hei 7-266614).

The full-color image forming apparatus has the function of outputting various information images, at a density such that it is difficult to visually recognize (discriminate) the information images on the recording material, by using color toner providing a small brightness difference with respect to the recording material. Such a function is used, e.g., in the case where copying of securities and confidential (secret) documents is automatically detected and terminated and the case where a machine (model) identification number of the image forming apparatus is embedded in a copy in an inconspicuous manner and is made analyzable from the copy.

More specifically, JP-A Hei 6-113109 discloses an image forming apparatus in which an information image of a numerical string or a character string is formed on a white background of an image by using yellow toner. In this case, an amount of toner per unit area (toner amount) of the information image varies depending on a change in image forming condition. For this reason, a patch image with a density corresponding to the density of the information image is formed and optically detected, so that the information image density is kept at a level such that it is difficult to visually recognize the information image.

Further, JP-A Hei i6-110988 and JP-A 2008-271110 disclose an image forming apparatus in which an information image of a dot pattern code is formed on the white background of the image by using the yellow toner.

Further, JP-A 2007-81750 discloses an image forming apparatus in which the forgery-preventing image for clearly indicating a difference between an original image and its copied image is outputted on the white background of the original image.

Here, the present inventor has found that the information image is conspicuous on the recording material when the transparent toner image is superposed (overlapped) on the information image even in the case where the information image is outputted on the recording material at a low density such that it is difficult to visually recognize the information image on the recording material as in JP-A Hei 6-113109. This may be attributable to such a phenomenon that a surface particulate nature of the color toner image constituting the information image is lowered when the transparent toner image is superposed on the information image and thus an amount of scattered light is decreased, so that a degree of whiteness is lowered and an apparent density of the information image is increased.

For a similar reason, also in the case where the forgery-preventing image is outputted as described in JP-A 2007-81750, the apparent density of the forgery-preventing image to be outputted as an originally inconspicuous halftone image is increased and becomes obtrusive.

Further, also in the case of a whole surface transparent image mode in which the transparent toner image is superposed on the information image or the forgery-preventing image in the entire image surface in order to uniformize glossiness of the resultant image, the information image or the forgery-preventing image which are required to be inconspicuous becomes conspicuous, so that the problem described above occurs. This problem becomes more serious in a partial transparent image mode in which the transparent toner image is formed in a pattern and is superposed on the information image or the forgery-preventing image at a part of the image surface. This is because the information image or the forgery-preventing image which becomes conspicuous due to the superposition of the transparent toner image on the information image or the forgery-preventing image causes the transparent toner image which is to be inconspicuous originally to be conspicuous, so that the partial transparent image mode loses its significance.

### SUMMARY OF THE INVENTION

A principal object of the present invention is to provide an image forming apparatus capable of preventing an information image and a forgery-preventing image which are formed with a color toner image from becoming conspicuous even when a transparent toner image is superposed on the color toner image.

According to an aspect of the present invention, there is provided an image forming apparatus comprising:

a photosensitive member;

an exposure device for exposing to light the photosensitive member to form an electrostatic latent image by using exposure image data for an output image to which an information image to be formed so as to be made difficult to be visually recognized with respect to background color has been added;

developing means for developing the electrostatic latent image with color toner into a color toner image;

transparent toner image forming means for forming a transparent toner image located on the color image on a recording material; and

image processing means for generating the exposure image data so that a toner amount of the information image on which the transparent toner image is superposed is less than that of the information image on which the transparent toner image is not superposed.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a constitution of an image forming apparatus.

FIG. 2 is an illustration of a constitution of a yellow image forming portion.

FIG. 3 is a graph showing a relationship between an image density of a patch image and an output of reflected light amount sensor.

FIGS. 4(a) to 4(c) are illustrations each showing a transparent image mode.

FIG. 5 is a diagram for illustrating image processing of a read image.

FIGS. 6(a) and 6(b) are illustrations each showing a discriminating pattern intrinsic to the image forming apparatus.

FIG. 7 is a schematic view for illustrating measurement of spectral reflectance of an information image.

FIGS. 8(a) and 8(b) are schematic views for illustrating an increase in apparent density when a transparent toner image is superposed on a color toner image.

FIG. 9 is a graph for illustrating setting of an exposure modulation amount of the information image in Embodiment 1.

FIG. 10 is a flow chart of control in Embodiment 1.

FIG. 11 is an illustration of a color chart used in Embodiment 2.

FIGS. 12(a), 12(b) and 12(c) are illustrations of an information image in Embodiment 3.

FIGS. 13(a), 13(b) and 13(c) are illustrations of an information image in Embodiment 4.

FIGS. 14(a) and 14(b) are illustrations of an information image in Embodiment 5.

### DESCRIPTION OF THE PREFERRED EMBODIMENTS

Hereinbelow, embodiments of the present invention will be described with reference to the drawings. The present invention can also be carried out in other embodiments in which a part or all of constitutions are replaced by alternative constitutions so long as an exposure image data is corrected so as to lower a density of a color toner image on which a transparent toner image is superposed.

Therefore, the present invention can be carried out irrespective of a difference between a tandem type and a one-drum type and a difference between an intermediary transfer type and a direct transfer type. That is, the present invention can be carried out by not only an image forming apparatus of the tandem type including a plurality of image forming portions inclusive of a transparent image forming portion but also an image forming apparatus including an independent transparent image forming portion and an image forming system including a single transparent image forming apparatus connected to a full-color image forming apparatus on a downstream side with respect to a recording material conveyance direction. In the following embodiments, a principal portion relating to formation and transfer of a toner image will be described but the present invention can be carried out in various fields of a printer, various printing machines, a copying machine, a facsimile machine, a multi-function machine, and the like by adding necessary equipment, device and casing structure.

Incidentally, general matters of the image forming apparatuses, information images and forgery-preventing images described in JP-A Hei 7-266614, JP-A Hei 6-113109, JP-A Hei 6-110988, JP-A 2008-271110 and JP-A 2007-81750 will be omitted from illustration and redundant description.

### (Image Forming Apparatus)

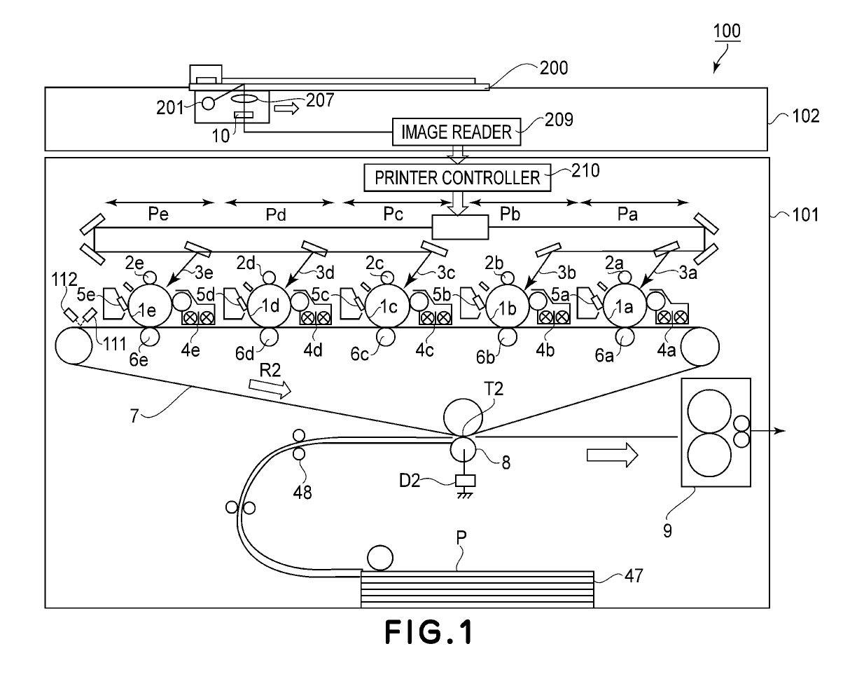

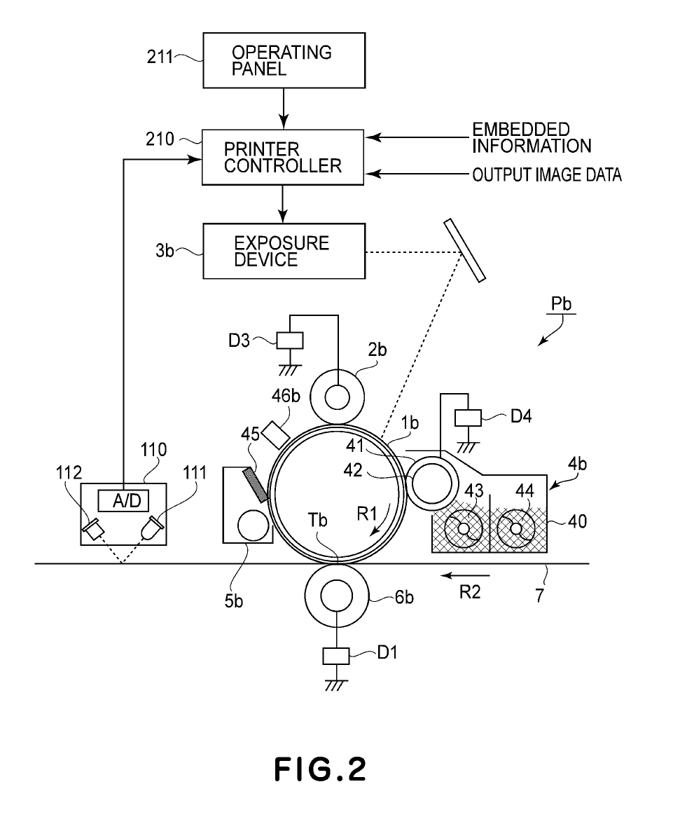

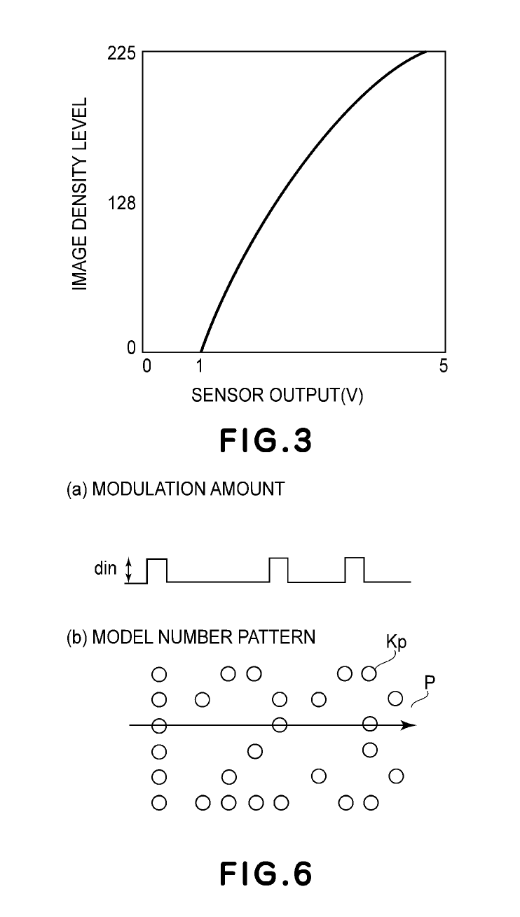

FIG. 1 is an illustration of a constitution of the image forming apparatus. FIG. 2 is an illustration of a constitution of a yellow image forming portion. FIG. 3 is a graph showing a relationship between an image density of a patch image and an output of a reflected light amount sensor.

As shown in FIG. 1, an image forming apparatus 100 includes an image forming unit 101 and an image reading unit 102 disposed on the image forming unit 101. The image forming apparatus 100 is an intermediary transfer type full-color printer of the tandem type in which image forming portions Pa for clear (transparent), Pb for yellow, Pe for magenta, Pd for cyan and Pe for black are arranged along an intermediary transfer belt 7.

At the image forming portion Pb as an example of color toner image forming means, a yellow toner image is formed on a photosensitive drum 1b and then is primary-transferred onto the intermediary transfer belt 7. At the image forming portion Pc, a magenta toner image is formed on a photosensitive drum 1c and then is primary-transferred superposedly onto the yellow toner image on the intermediary transfer belt 7. At the image forming portions Pd and Pe, a cyan toner image and a black toner image are formed on a photosensitive drum 1d and a photosensitive drum 1e, respectively and then are successively primary-transferred superposedly onto the intermediary transfer belt 7.

The image forming portion Pa as an example of a transparent toner image forming means is used in an image mode using the transparent toner image. At the image forming portion Pa, a clear (transparent) toner image is formed on a photosensitive drum 1a and then is primary-transferred onto the intermediary transfer belt 7 as a lowermost layer.

The fine color toner images in total (including the transparent toner image) are conveyed to a secondary transfer portion T2 by rotation of the intermediary transfer belt 7 and are collectively secondary-transferred onto a recording material P. That is, the recording material P picked up from a recording material cassette 47 is separated one by one and fed to registration rollers 48, by which the recording material P is sent to the secondary transfer portion T2 while being timed to the toner images on the intermediary transfer belt 7.

The recording material P on which the fine color toner images in total are secondary-transferred are curvature-separated from the intermediary transfer belt 7 on a downstream side of the secondary transfer portion T2 with respect to a recording material conveyance direction and is conveyed into a fixing device 9. The recording material P is heated and pressed in the fixing device 9 to fix thereon the toner images, so that the recording material P is discharged outside the image forming apparatus.

The image forming portions Pa, Pb, Pc, Pd and Pe are substantially constituted similarly except that the colors of two component develops used in developing devices 4a, 4b, 4c, 4d and 4e are different from each other. In the following description, the yellow image forming portion Pb will be described and with respect to other image forming portions Pa, Pc, Pd and Pe, the suffix b added for representing constituent members or means with respect to the yellow image forming portion Pb is read as a, c, d and e.

As shown in FIG. 2, the image forming portion Pb includes the photosensitive drum 1b as an example of a photosensitive member and includes, around the photosensitive drum 1b, a charging roller 2b, an exposure device 3b, a developing device 4b, a primary transfer roller 6b, a cleaning device 5b, and a discharging exposure device 46b.

The photosensitive drum 1b is prepared by forming a negatively chargeable photosensitive layer on an outer surface of an aluminum cylinder and is rotated in a direction indicated by an arrow R1 at a predetermined process speed. The charging roller 2b is supplied with an oscillating voltage in the form of a DC voltage biased with an AC voltage, from a power source D3, thus uniformly charging the surface of the photosensitive drum 1b to a negative dark portion potential VD. The exposure device 3b writes an electrostatic latent image for an image on the surface of the photosensitive drum 1b by scanning the surface of the photosensitive drum 1b with a laser beam obtained by subjecting scanning line image data expanded from a yellow separated color image to ON-OFF modulation.

The developing device 4b includes a developer container 40 in which a two component developer containing yellow non-magnetic toner and a magnetic carrier in mixture is contained in a predetermined amount. The two component developer in the developer container 40 is triboelectrically charged so that the magnetic carrier is positively charged and the non-magnetic toner is negatively charged during a circulating process in the developing container 40 in which the developer is conveyed in opposite directions perpendicular to the drawing surface by conveying screws 43 and 44. The two component developer is carried on a developing sleeve 41 rotating around a fixed magnet 42 and rubs against the photosensitive drum 1b in an erected chain state. A power source D4 applies an oscillating voltage in the form of a negative DC voltage Vdc biased with an AC voltage to the developing sleeve 41. As a result, the toner carried on the developing sleeve 41 is transferred onto an exposed portion of the photosensitive drum 1b which is positive relative to the dark portion, so that the electrostatic image is reversely developed.

The primary transfer roller 6b urges an inner surface of the intermediary transfer belt 7 to form a primary transfer portion Tb between the photosensitive drum 1b and the intermediary transfer belt 7. By applying a positive DC voltage from a power source D1 to the primary transfer roller 6b, the negative toner image carried on the photosensitive drum 1b is primary-transferred onto the intermediary transfer belt 7 passing through the primary transfer portion Tb.

The cleaning device 5b removes transfer residual toner, which has passed through the primary transfer portion Tb without being primary-transferred, by rubbing the photosensitive drum 1b with a cleaning blade 45.

### (Image Density Control)

Image density adjustment of the color toner image is performed by forming a patch image under a predetermined image forming condition individually at the image forming portions Pb, Pc, Pd and Pe, primary-transferring the patch image onto the intermediary transfer belt 7, and then detecting the density of the patch image by a reflected light amount sensor 110.

A reflected light amount corresponding to a toner amount (per unit area) is obtained by irradiating the patch image which has been primary-transferred onto the intermediary transfer belt 7 with light by an LED light source 111 and then by receiving reflected light by a photo-diode 112. This is because the output light from the LED light source 11 has a reflection property with respect to the toner and has a moderate reflection property with respect to the intermediary transfer belt 7. An analog signal from the photo-diode 112 is converted into a digital signal as shown in FIG. 3 by an A/D converter incorporated in the reflected light amount sensor 110.

A printer control portion 210 adjusts the image forming condition on the basis of density information obtained by the reflected light amount sensor 110. In order to change the toner amount with respect to the same electrostatic image, an amount of toner supplied to the developing device 4b is adjusted, so that a charge amount of the toner is changed. In order to adjust the toner amount by changing the electrostatic image, the DC voltage applied to the charging roller 2b, the DC voltage applied to the developing sleeve 41 or the exposure output of the exposure device 3b is changed.

### (Image Forming Mode)

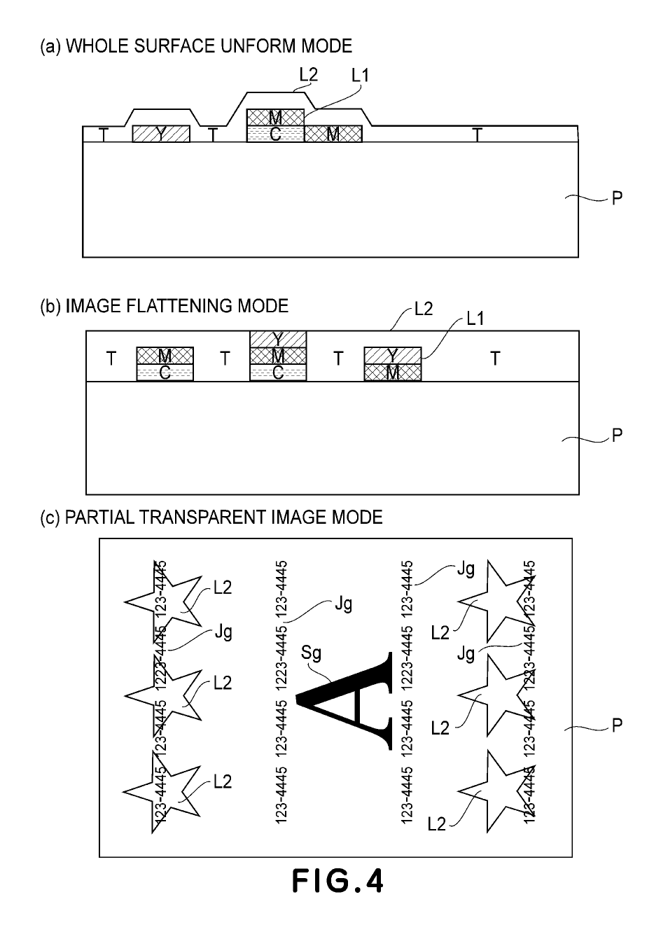

FIGS. 4(a), 4(b) and 4(c) are illustrations of the transparent image mode. The image forming apparatus 100 is operable in a full-color mode (color image mode) in which image formation is effected by using the color toner images of yellow, magenta, cyan and black and a black (monochromatic) mode in which only the black toner image is used. Further, the image forming apparatus 100 is operable in the transparent image mode in which the image formation is effected by superposing the transparent toner image on the full-color image or the black (monochromatic) image. These modes can be switched by user is instructions. The image forming mode is switched by a controller provided in the apparatus main assembly on the basis of instruction information inputted from an operating panel as a designating means or a personal computer or the like through a network interface.

Incidentally, as the type of the color toner images, it is also possible to combine colors other than yellow, magenta, cyan and black. For example, the image formation is effected by using both of dark color toners of magenta and cyan and light color toners of magenta and cyan which have the same hues but are smaller in density than those of the dark color toners, so that it is possible to improve color reproducibility of a halftone image.

As shown in FIGS. 4(a), 4(b) and 4(c), in the image forming apparatus 100 (FIG. 1), the following three types of the transparent image modes are selectable.

### (1) Whole Transparent Image Mode (Whole Surface Uniform Mode)

As shown in FIG. 4(a), a transparent toner image L2 is superposed in a uniform toner amount on a whole surface of the recording material P including a color toner image L1 and a white background portion, so that a uniformly high-glossy output image is obtained.

### (2) Image Flattening Mode

As shown in FIG. 4(b), the transparent toner image L2 is formed and superposed on the color toner image L1 so that a height of the resultant toner layer before the fixing is uniform over the whole image surface (reverse LUT mode).

### (3) Partial Transparent Image Mode

As shown in FIG. 4(c), gloss is partly provided by placing a graphic pattern or a character pattern of the transparent toner image L2 on a part of the recording material P on which the color toner image is formed.

The partial transparent image mode (3) also functions as a method in which an image formed output product (document) is protected from copying. Specifically, such a constitution that a part of contents can be easily observed by the user but cannot be detected by the image reading unit 102.

### Embodiment 1

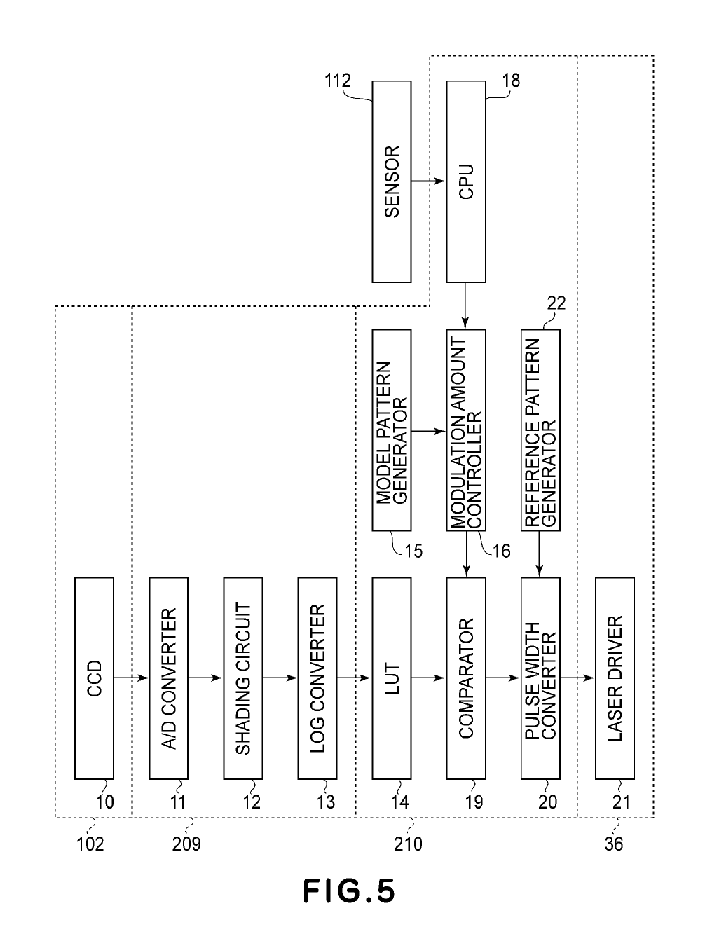

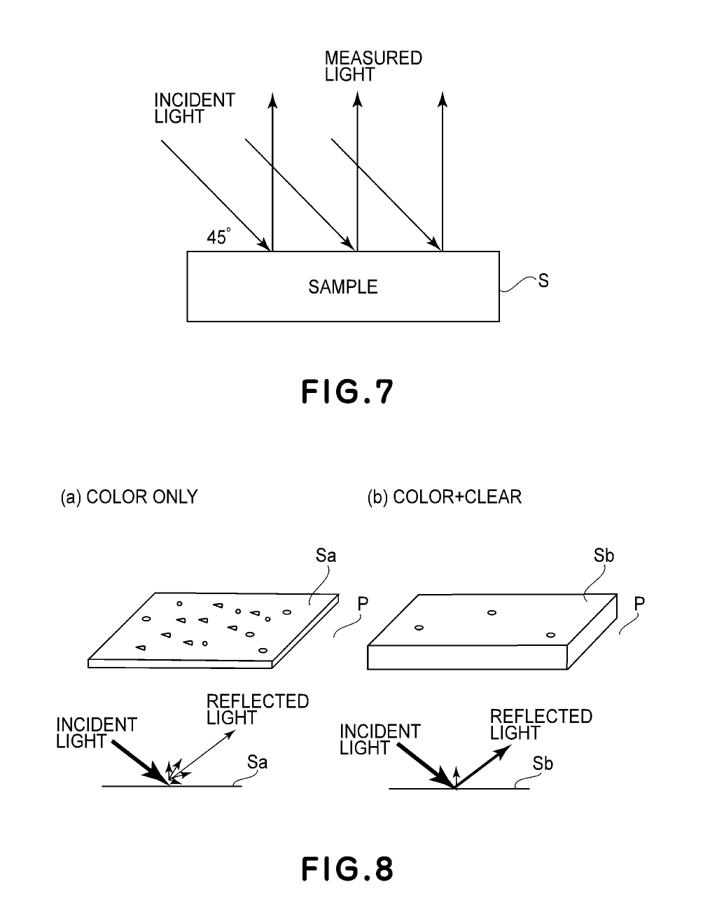

FIG. 5 is a diagram for illustrating image processing of a read image. FIGS. 6(a) and 6(b) are illustrations each showing a discriminating pattern (information image) intrinsic to the image forming apparatus. FIG. 7 is a schematic view for illustrating measurement of spectral reflectance of an information image. FIGS. 8(a) and 8(b) are schematic views for illustrating an increase in apparent density when a transparent toner image is superposed on a color toner image.

In this embodiment, image processing in which a gradation image is obtained by the image reading device and an information image is subjected to superposition will be described but it is also possible to subject the information image to embedding processing in a similar procedure even with respect to the gradation image inputted from external equipment such as the personal computer.

The image forming apparatus 100 adds a discriminating pattern intrinsic thereto to a part of the yellow toner image as described in JP-A Hei 6-113109, thus forming the information image so that it is difficult to visually recognize (discriminate) the discriminating pattern with respect to background color of the recording material P.

As shown in FIG. 1, in a copy mode, the image reading unit 102 reads an image of an original placed on an original supporting platen glass 200. An exposure lamp is consisting of any one of a fluorescent lamp, a halogen lamp, a laser, an LED, and the like and irradiates the original on the original supporting platen glass 200 with light while moving in a direction perpendicular to its longitudinal direction. Scattered light from the original by the light irradiation of the exposure lamp 201 reaches a lens 207.

The original image is focused on a light receiving portion of a CCD (line sensor) 10 including several thousand light receiving elements arranged in a line and is subjected to real time photoelectric conversion on a line basis. A read signal of the original image which has been subjected to the photoelectric conversions is processed by a reader image processing portion 209 and is outputted as a read image data to the printer control portion 210.

The printer control portion 210 prepares an exposure image data for an output image including the read image and the information image added to the read image and expands the exposure image data and then subject the expanded exposure image data to PWM (pulse width modulation) to generate a scanning line exposure signal. Then, by using the scanning line exposure signal, a laser beam light source (semiconductor laser) of the exposure device 3b is driven.

As shown in FIG. 5, a brightness (luminance) signal of the original image is obtained by the CCD 10 and is converted into a digital brightness by an A/D conversion circuit 11. The resultant brightness signal is corrected by a shading circuit 12 with respect to a variation in sensitivity of individual CCD elements of the CCD (line sensor) 10. The corrected brightness signal is converted into a density signal by a LOG conversion circuit 13.

A look-up table (LUT) 14 of the printer control portion 210 converts a pixel density into an exposure condition on the basis of a γ-characteristic of the printer during initial setting so that the image density of the original coincides with that of the output image.

In this embodiment, a model number pattern refers to an image pattern corresponding to the number intrinsic to the image forming apparatus 100. A model number pattern generating circuit 15 generates a discriminating pattern (identification pattern) intrinsic to the image forming apparatus 100. A numerical value pattern shown in FIG. 6 is superposed on an image signal of the yellow toner image which provides lowest resolving power by eye observation. Incidentally, the model number pattern is not limited to the numerical value pattern associated with the model number but may preferably be a pattern which corresponds to the numerical value or a character and is less conspicuous.

A modulation amount (exposure condition) of the pattern to be superposed is computed as an optimum value by a CPU 18 from a value obtained by the sensor 112 for measuring the reflected light amount of the patch image on the intermediary transfer belt 7. At this time, in the case where the transparent image mode is selected, as described later, the modulation amount is computed so that the toner amount is smaller than that in the case where the color toner image mode is selected by correcting the modulation amount of the pattern to be superposed. A reference pattern generating circuit 22 generates a halftone data when the patch image is formed on the intermediary transfer belt 7 at a reference density.

A modulation amount control circuit 16 performs modulation of the model number pattern by using a computed value of the optimum modulation amount computed by the CPU 18. The modulated model number pattern is synthesized as an image signal by a comparator circuit 19.

The image signal superposed with the model number pattern is then subjected to the PWM so as to be a laser emission time proportional to the density signal. The scanning line exposure signal which has been subjected to the PWM is sent to a laser driver circuit 21 and a laser beam represents density gradation in the form of area gradation, so that a gradation image is formed.

As shown in FIG. 6(b), a model number pattern Kp formed on the recording material P is formed, with a small exposure modulation amount din, at a very small density for yellow. The model number pattern Kp is embedded in the white background portion of the recording material P and cannot be observed by eyes. However, by observing the model number pattern through a sharp band filter of 350 nm, only a yellow signal can be separated and read. In the case where, a copy-inhibited document or the like is copied, as described in JP-A Hei 6-113109, by reading the model number pattern Kp from the copied product, it is possible to identify the image forming apparatus which has been used for copying the document.

Incidentally, an image which is principally aimed at appreciation such as photograph or a pamphlet may preferably be formed so that glassiness of the entire image is uniformized by superposing the transparent toner image to realize a high glossy image which provides a sense of depth and a sense of grace. For that reason, the whole surface uniform mode (1) or the image flattening mode (2) described above.

However, when the transparent toner image is superposed on the information image, an apparent density of the information image is increased although the toner amount of the information image is not changed. As a result, the information image which is originally formed so that it is difficult to visually recognize the information image with respect to the background color is changed to an easy-to-recognize information image.

For example, assuming that an information image Jg is formed on the recording material P in a toner amount at an inconspicuous level as shown in FIG. 4(c), when the transparent toner image L2 is superposed on a part of the information image Jg, the apparent density differs between an overlapping portion where the transparent toner image L2 is superposed on the information image Jg and a non-overlapping portion where the transparent toner image L2 is not superposed on the information image Jg. For this reason, the information image Jg which would not be visually recognized in a state in which the information image Jg is blended into the background color of the recording material P becomes clearly recognizable, so that a quality of the output image is deteriorated.

Here, when the transparent toner image is placed on the color toner image, compared with the case where the transparent toner image is not placed on the color toner image, a mechanism that a reflection density is increased will be described. As shown in FIG. 7, when spectral reflectance of the information image is measured with respect to a vertical direction for 45-degree incident light as shown in FIG. 7, a reflection density Dr can be represented by the following equation by using a spectral reflectance R:

Dr=−log R.

That is, when the spectral reflectance R is large in the measurement shown in FIG. 7, the reflection density Dr is lowered. In other words, when the surface of a measurement sample S is roughened to increase the amount of scattered light, the reflection density Dr is lowered. On the other hand, when the surface of the measurement sample S is mirror-finished and the incident light causes total reflection, there is substantially no spectral reflectance R and therefore the reflection density Dr is increased.

When the transparent toner image is superposed on the color toner image, glossiness (gloss) of a fixed image is increased compared with the case of the color toner image alone. This is because the toner of a surface layer of the fixed image is uniformly melted and diffused due to an increase in total toner amount and thus smoothness of the surface is increased thereby to enhance the glossiness.

As shown in FIG. 8(a), in the case where the image formation is effected by only the color toner image, a surface shape of a fixed image Sa is roughened by a phenomenon such that the white background portion of the recording material P is in sight from spacing among toner particles. For that reason, the incident light is scattered to increase an amount of the scattered light component, so that the reflection density Dr of the fixed image Sa is lowered.

On the other hand, as shown in FIG. 8(b), in the case where the image formation is effected by superposing the transparent toner image on the color toner image, the total toner amount is large and thus the white background portion of the recording material P is not in sight, so that the surface shape of the fixed image Sb is smooth. Therefore, the incident light is not scattered to decrease the amount of the scattered light component, so that the reflection density Dr of the fixed image Sb is increased.

Further, in the case where the fixed image outputted by superposing the transparent toner image on the color toner image is copied by the image forming apparatus 100, compared with the case where the fixed image consisting only of the color toner image is copied, the reflection density of the fixed image for each color is increased. The reason is as follows.

In the case of the copying, when the image reading unit 102 reads the original image as shown in FIG. 1, the fixed image obtained by superposing the transparent toner image on the color toner image has the smooth surface and high glossiness, so that the amount of the scattered light component is small. On the other hand, the surface of the fixed image consisting only of the color toner image is not smooth, so that the amount of the scattered light component is large. When the amount of the scattered light component is small, compared with the case where the amount of the scattered light component is large, a higher reflection density Dr is detected, so that the image forming unit 101 outputs a higher density image.

For example, in the case where a mirror or the like which does not generate the scattered light component is subjected to color copying, the image forming unit 101 forms solid images for respective colors with respect to the mirror portion, so that a four-color based solid black image is outputted.

As described above, in the case where the fixed image obtained by superposing the transparent toner image on the color toner image is copied, compared with the case where the fixed image consisting only of the color toner image is copied, the model number pattern of the information image is emphasized with a high density and is outputted as a copy with the high density. The image reading unit 102 is capable of detecting the yellow toner image with the information image density in order to perform a copy-inhibiting operation or the like by reading the information image. However, the information image is prevented from being copied by removing a yellow toner image component with a density which is a predetermined threshold density or less. In this embodiment, the information image on which the transparent toner image is superposed has the density which exceeds the threshold density is copied.

### Control in Embodiment 1

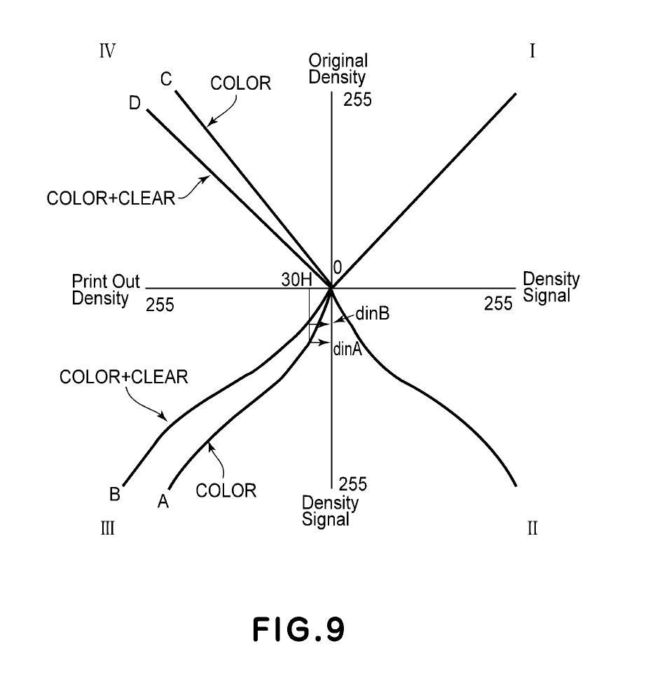

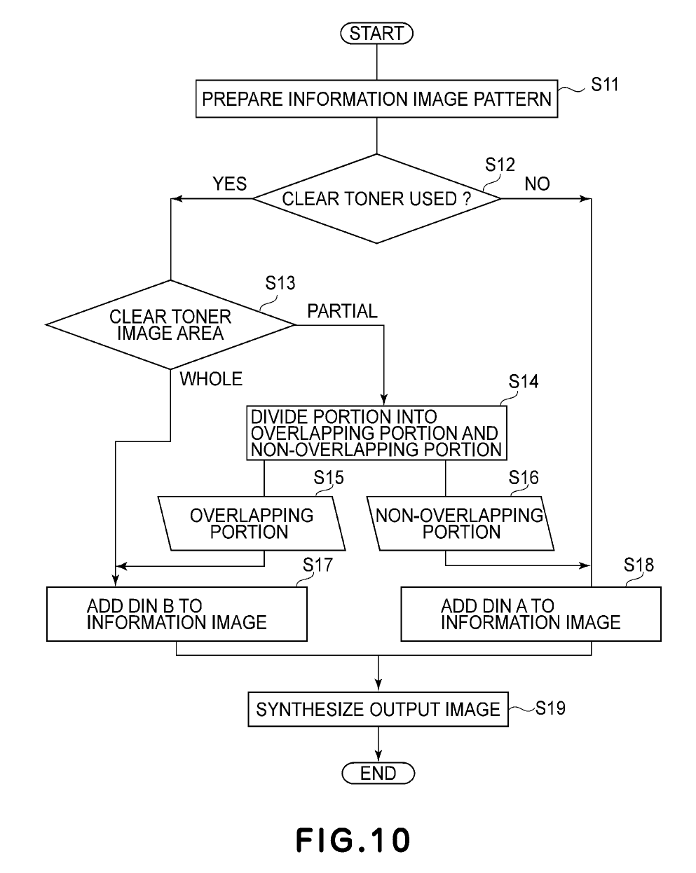

FIG. 9 is a graph for illustrating setting of the exposure modulation amount of the information image in Embodiment 1. FIG. 10 is a flow chart of control in Embodiment 1.

As shown in FIG. 9, a total gradation characteristic of the image forming apparatus 100 is represented by a four-quadrant chart. In accordance with this four-quadrant chart, gradation levels of the image density are represented. In FIG. 9, the first quadrant (I) shows a reader characteristic for converting the original density into the density signal. The second quadrant (II) shows an LUT for converting the density signal into a laser output signal. The third quadrant (III) shows a printer characteristic for converting the laser output signal into an output density. The number of the gradation levels is 256 since processing is effected by using 8 bit-digital signal.

It has been known that the printer characteristic in the third quadrant (III) is changed into various shapes depending on conditions such as a photosensitive property of the photosensitive drum 1b, a laser spot diameter, a developing property, and the like. In this embodiment, an S-shaped printer characteristic will be described.

In the fourth quadrant (IV), it is important that a total gradation characteristic showing a relationship between an original density (Y-axis) and an output density (X-axis) is made linear in order to faithfully reproduce the full-color image. For that purpose, there is need to change the LUT in the third quadrant (III) into the S shape.

The printer characteristic in the case of using only the color toner image is represented by a curve A in the third quadrant (III). In this case, the total gradation characteristic is represented by a line C in the fourth quadrant (IV), so that a linearity of gradation is maintained.

On the other hand, the printer characteristic in the case where the transparent toner image is superposed on the color toner image in a certain amount is represented by a curve B. In this case, the total gradation characteristic is represented by a line D, so that the linearity of gradation is maintained.

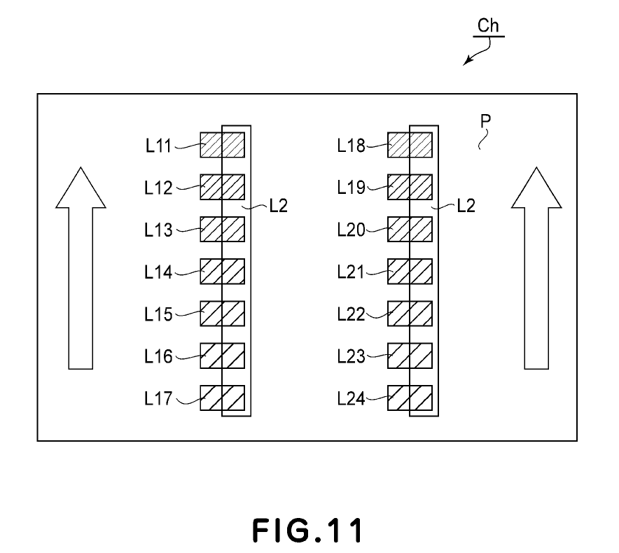

Incidentally, the curve B in the third quadrant (III) was prepared by superposing a solid transparent toner image with a maximum density on yellow patch image of a plurality of gradation levels to form an image (FIG. 11) and then by reading a resultant fixed image. As a reflection density meter, a spectrodensitometer (“X-Rite 505”, mfd. by X-Rite Co., Ltd.) was used, and a measured value was inputted through the operating panel 211. On the basis of the measured value, the printer controller 210 calculated a relationship between the toner amount and the reflection density and prepared a one-dimensional LUT (gradation correction table) so as to provide a desired characteristic (density linearity, brightness linearity, or the like).

The modulation signal of the model number pattern is determined on the basis of the third quadrant (III). In this embodiment, the modulation signal of the model number pattern was determined so that a print output density of the fixed image was at a level of 30 (H).

In the case where the image is formed by only the color toner image, an input signal value din A (density difference level) when a signal level after output at the gradation A is 30 H is a density modulation signal to be assigned to the model number pattern.

On the other hand, in the case where the image is formed by superposing the transparent toner image on the color toner image, a input signal value din B (density difference level) when the signal level after output at the gradation B is 30 H is assigned to the model number pattern.

That is, the input signal value for the exposure of the model number pattern was set so that the fixed image of the yellow toner image alone and the fixed image obtained by superposing the transparent toner image on the yellow toner image were read at the same signal level (=30 H) by the image reading portion 102 (FIG. 1). As a result, in the case where the patch image is formed at an exposure density for each of the model number patterns, the yellow toner amount for the fixed image obtained by superposing the transparent toner image on the yellow toner image is smaller than that for the fixed image of the yellow toner image alone. When the patch image is primary-transferred on the intermediary transfer belt 7 and is detected by the reflected light amount sensor 110, signals corresponding to the input signal values din A and din B are detected (on the negative side of the Y-axis).

In the case of the color toner image alone, the model number pattern is exposed to light at the input signal value din A but in the case where the transparent toner image is superposed on the color toner image, the model number pattern is exposed to light at the input signal value din B. As a result, the resultant image densities after the fixing were apparently substantially equal to each other and the model number pattern was not conspicuous even at the overlapping portion of the transparent toner image, so that the model number pattern was not conspicuous on the copied image. That is, when at least a mode in which the whole surface area of the sheet is covered with the transparent toner is executed, compared with the case where a mode in which the transparent toner is not used, the yellow toner amount is controlled by the controller so that an amount per unit area of the yellow toner used for forming a pattern image to be concealed is small. That is, in the case of the partial transparent image mode in which the transparent toner image is partly formed, the toner amount at the model number pattern portion where the transparent toner image is superposed on the model number pattern as the information image is smaller than that at the model number pattern portion where the transparent toner image is not superposed on the model number pattern. Further, the toner amount at the model number pattern portion as the information image in the whole surface transparent mode is smaller than that of the model number pattern portion as the information image in the color toner image mode in which the transparent toner is not used.

As shown in FIG. 10 with reference to FIG. 2, the printer control portion 210 turns on the main power and then automatically actuates and executes control for determining the exposure modulation amount (din) for the model number pattern after completion of warm-up.

First, the printer control portion 210 forms the model number pattern as the information image (S11). Then, in the case of a normal mode in which the transparent toner image is not superposed with respect to the output image (NO of S12), the model number pattern is prepared at the input signal value din A (density difference level) (S18). The density difference level is set as a difference between the yellow density of the model number pattern and the background color of the recording material P in order to put the model number pattern out of sight with reliability while ensuring a reading S/N ratio.

In the case of the transparent image mode in which the transparent toner image is superposed on the color toner image (YES of S12), the printer control portion 210 judges whether or not the transparent toner image is to be formed on the whole surface of the image forming area (S13). The printer control portion 210 judges that the print mode is the normal mode, (1) whole surface uniform mode, (2) image flattening mode, or (3) partial transparent image mode, on the basis of print information obtained by the operation through the operating panel 211 or sent from an external device. The printer control portion 210 determines, on the basis of this discrimination result, whether the transparent toner image is formed on the whole surface or a part of the surface in the case of print output. However, in the case of copy output performed by reading the original image by the image reading portion 102, the transparent toner image is automatically formed in (1) whole surface uniform mode.

In the case of (1) whole surface uniform mode or (2) image flattening mode (WHOLE of S13), the printer control portion 210 prepares the model number pattern uniformly at the input signal value din B (S17).

However, in the case of (3) partial transparent image mode (PARTIAL of S13), the printer control portion 210 divides the image forming area into the model number pattern portion (overlapping portion) where the transparent toner image is superposed and the model number pattern portion (non-overlapping portion) where the transparent toner image is not superposed (S14). At the overlapping portion (S15), the model number pattern is prepared at the input signal value din B (S17). Further, at the non-overlapping portion (S16), the model number pattern is prepared at the input signal value din A (S18).

As shown in FIG. 4(c), in the case of image formation in which the transparent toner image L2 is formed on the recording material P only at star portions, a plurality of model number pattern Jg forming manners in which the input signal values din A and din B are used outside and inside the star portions, respectively, is employed. Different exposure modulation amounts (din) are set for the information image Jg on which the star-like transparent toner image L2 is superposed and the information image Jg on which the star-like transparent toner image L2 is not superposed.

In the case where the exposure is performed at the input signal value din A, compared with the case where the exposure is performed at the input signal value din B, the toner amount at one pixel after the output by the printer is large. The control of the exposure device 3b using the input signal values din A and din B may be effected by changing an output level of laser power or by changing a pulse length (width). In this embodiment, the PMW in which the pulse length is modulated depending on the gradation level was employed.

Through the operation described above, the information image data for which the input signal values din A and din B are set every place of the model number pattern is synthesized in the output image data (S19). In this case, only the information image data corresponding to the white background portion of the output image is synthesized in the output image data and the information image data at a portion where the color toner image of the output image is superposed on the information image is disregarded.

In this embodiment, in the case of the image formation using only the color toner image, the input signal value din A is provided to the model number pattern on the basis of the characteristic of gradation A. On the other hand, in the case where the image is formed by superposing the transparent toner image on the color toner image, the input signal value din B is provided to the model number pattern on the basis of the characteristic of gradation B. For this reason, in the case where the transparent toner image is superposed on the color toner image, the model number pattern is prevented from being conspicuous due to its high density.

Further, the same output level of the printer is set at 30 H with respect to both the case of the presence of the transparent toner image and the case of the absence of the transparent toner image, so that the model number pattern was able to be detected with no problem even when the model number pattern forming manner was changed.

Incidentally, the control for determining the exposure modulation amount (din) of the model number pattern may also be effected during pre-rotation every time when a job is received or during post-rotation after completion of the job. Further, the image forming apparatus 100 may also be configured as an image forming system in which the image forming portion for forming the transparent toner image is separated from the image forming portions for forming the color toner images.

### Embodiment 2

FIG. 11 is an illustration of a color chart used in this embodiment. In Embodiment 1, the example in which the density difference of the level of 30 (H) is provided between the print output density of the model number pattern and the background color of the recording material P is described but this level may desirably be set at an optimum level depending on a fluctuation in printer characteristic.

JP-A Hei 6-113109 discloses control in which the information image density is periodically set again by periodically forming the patch image with a density corresponding to the information image density and then by measuring the toner amount through the reflected light amount sensor in order to meet the change in image forming condition with time.

On the other hand, in this embodiment, as shown in FIG. 2, a manual setting mode is executed through the operating panel 211, so that the exposure input signal values din A and din B applied with respect to the information image are set by manual input. Similarly as in Embodiment 1, the exposure input signal value din A is applied with respect to the information image at the non-overlapping portion of the transparent toner image, and the exposure input signal value din B is applied with respect to the information image at the overlapping portion of the transparent toner image.

When the manual setting mode is selected through the operating panel 211, a color chart Ch shown in FIG. 11 is outputted. In the color chart Ch, 14 patch images L11 to L24 with output gradation levels 16 to 68 which are used for PWM exposure while changing the gradation level by 4/256 for each output gradation level are disposed on the recording material P. In each patch image, half of the area is covered with the transparent toner image L2 with a maximum output gradation level (solid image). To each of the patch images L11 to L24, an identification number is added.

An operator measures the reflection density at the portion which is not covered with the transparent toner image L2 and the portion covered with the transparent toner image L2 with respect to each of the patch images L11 to L24 of the outputted color chart Ch. Then, the operator manually inputs the patch image identification number, corresponding to the reflection density determined for the information image, in the operating panel 211 with respect to each of the case where the transparent toner image is superposed and the case where the transparent toner image is not superposed. On the basis of the inputted patch image identification number, the printer control portion 210 sets the exposure din A in the case where the transparent toner image is not superposed and the exposure input signal value din B in the case where the transparent toner image is superposed.

In this embodiment, as the reflection density meter, the X-Rite 503 spectrodensitometer was used, and the density difference within 0.05 between the case where the transparent toner image was not superposed and the case where the transparent toner image was superposed was set.

After the manual setting, the toner amount of the patch image which has been primary-transferred onto the intermediary transfer belt 7 is read by the reflected light amount sensor 110, so that the exposure input signal value din B is automatically adjusted so that the model number pattern is reproduced with the toner amount at the time of the setting. The printer control portion 210 forms the patch image at the set exposure input signal value din B, and the reflected light amount is read by the reflected light amount sensor. The resultant reflected light amount value is obtained as a reference value for toner amount judgment. Then, the patch image is periodically formed at the input signal value din B and is subjected to measurement of the reflected light amount, and the input signal value din B is adjusted so that the reflected light amount converts to the reference value. As a result, the image density of the model number pattern is kept at a level at which the model number pattern is inconspicuous and the reading S/N ratio can be sufficiently ensured.

Incidentally, it is also possible to automatically effect the control in this embodiment by reading the patch images L11 and L24 of the color chart Ch by using the image reading portion 102. The image reading portion 102 can read the information image formed by the yellow toner image at the level of 30 (H) so that the operation of copy inhibition or the like can be performed by reading the information image.

However, as described above, with respect to the yellow toner image having the density difference of the level of 30 (H) on the white background of the recording material P, the image reading portion 102 cannot accurately measure the subtleties of the density of the patch images L11 to L24.

Therefore, in the case where the image reading portion 102 is used in place of the reflected density meter, another recording material having blue background color may also be used for forming the color chart Ch to remarkably increase a density contrast of yellow. It is also possible to perform the reading in a state in which the output light amount of an exposure lamp 201 of the image reading portion 102 is temporarily increased to enhance the yellow density contrast.

### Embodiment 3

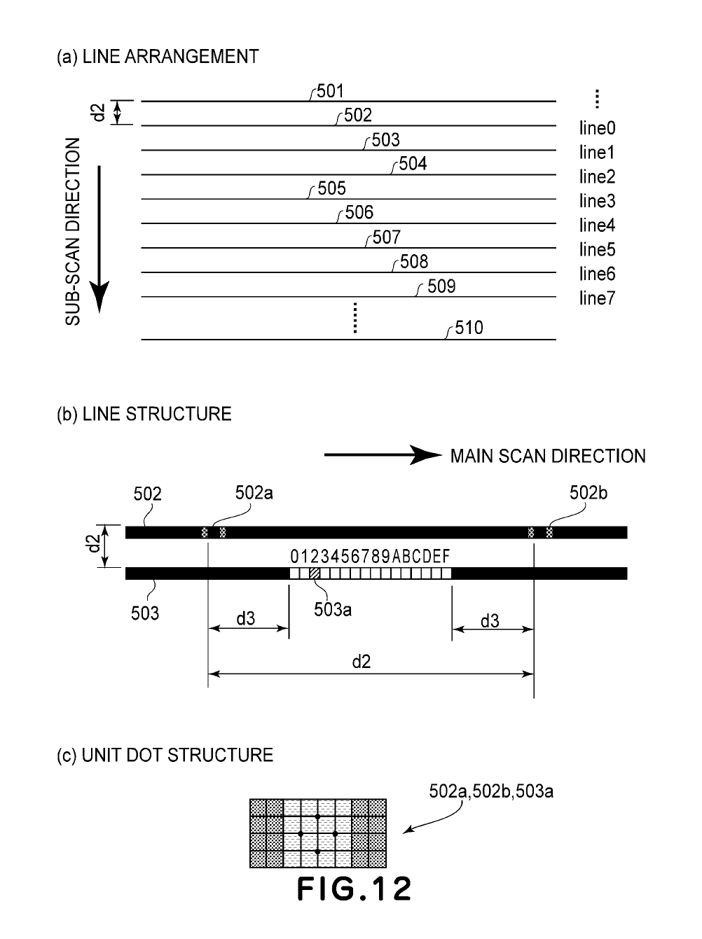

FIGS. 12(a), 12(b) and 12(c) are schematic views for illustrating the information image in this embodiment. In this embodiment, similarly as in Embodiment 1, in the image forming apparatus 100, the information image is printed on the recording material at the white background portion of the image by using the yellow toner image so as not to be conspicuous. Further, similarly as in Embodiment 1, the toner amount of the yellow toner image is made different between the information image on which the transparent toner image is superposed and the information image on which the transparent toner image is not superposed and thus the information image is inconspicuous even when the transparent toner image is superposed thereon. However, in this embodiment, the information image is not the model number pattern but is distributed over the entire surface area in the form of code information using a dot pattern as described in JP-A Hei 6-113109.

The general structure and control of the image forming apparatus 100, the detection of the superposition of the transparent toner image on the color toner image, the setting of the exposure input signal values din A and din B with respect to the information image depending on the presence or absence of the superposition, and the like are similarly to those in Embodiment 1, thus being omitted from description.

As shown in FIG. 12(a), each of add-on lines 501 to 510 has a four-pixel width and is arranged substantially regular period of d2=16 pixels in a sub-scan direction of the recording material. In one add-on line, 4-bit numerical value data is embedded, so that 8 add-on lines 502 to 509 (lines 0 to 7) are used as one group and can store 4×8=32 bit numerical value data in total. The add-on lines 501 to 510 extends in a main scan direction and are repeated formed in the sub-scan direction. Further, the same numerical value data is embedded in the add-on line 501 and the add-on line 509.

As shown in FIG. 12(b), the add-on lines 502 and 503 are adjacent to each other with respect to the sub-scan direction. In the add-on line 502, unit dots 502a and 502b which constitute a clock (mark or indicator) when the numerical value data embedded in the add-on line 502 is read are repeatedly formed with a certain distance d2 (=32 pixels).

On the add-on line 503, only a unit dot 503a for representing the numerical value data is disposed between the unit dots 502a and 502b. The 4-bit numerical value data is read depending on the distance from the unit dot 502a to the unit dot 502b.

The numerical value data represented by the unit dots 502a and 502b are determined by a phase difference, between the unit dots 502a and 502b, represented by 0 to F indicated in FIG. 12(b). In FIG. 12(b), the unit dot 503a represents the numerical value data “2”. In positions from “0” to “F”, when the unit dot 503a is located at the leftmost-hand end, the unit dot 503a represents “0”, and when the unit dot 503a is located at the rightmost-hand end, the unit dot 503a represents “F”.

As shown in FIG. 12(c), each of the unit dots 502a, 502b and 503a has a 4-pixel width and a 8-pixel length on the add-on line. Each unit dot is formed by 8×4 pixels and is a dot pattern of 4 pixels in length with 2-pixel width spacing before and after the unit dot with respect to the main scan direction. The reason why the unit dot is formed by the 8×4 pixels is that the density and reading S/N ratio are low and therefore it can be difficult to read the unit dot 503a when the unit dot is formed at a resolution which is less than that of the 8×4 pixels.

The add-on lines 501 to 510 are added by using only the yellow toner based on the fact that discrimination capability of human eyes is low with respect to a pattern formed by only the yellow toner. A dot interval of the add-on lines 501 to 510 with respect to the main scan direction and a repetition interval of recording information with respect to the sub-scan direction are determined so that the unit dot is discriminated with reliability and full information is decoded with respect to a specific original to be used.

In the add-on lines 501 to 510, the (manufacturer's) serial number intrinsic to the copying machine or a coded or symbolized number thereof is recorded. For this reason, in the case where illegal or pirated copying is performed, the illegal copy product is authenticated to read the added information from the add-on lines 501 to 510, so that the copying machine used for the illegal copying can be identified.

Incidentally, when the add-on lines 501 to 510 are added in the output image, complementary image signal modulations may also be combined in a small area and the density is maintained as a whole, so that the change in color may be eliminated to reduce a degree of image quality deterioration. In the case where the add-on lines are microscopically observed by the complementary image signal modulations, the added density can be easily discriminated, so that there is also such an advantage that the decoding of the added information can be effected with high reliability.

### Embodiment 4

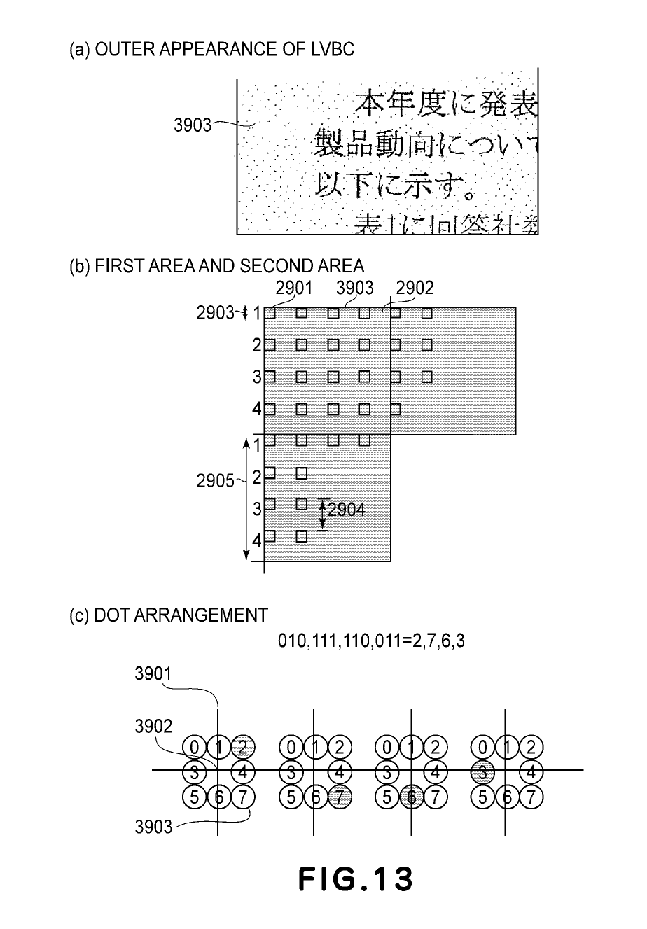

FIGS. 13(a), 13(b) and 13(c) are schematic views for illustrating the information image in this embodiment. In this embodiment, similarly as in Embodiment 1, in the image forming apparatus 100, the information image is printed on the recording material at the white background portion of the image by using the yellow toner image so as not to be conspicuous. Further, similarly as in Embodiment 1, the toner amount of the yellow toner image is made different between the information image on which the transparent toner image is superposed and the information image on which the transparent toner image is not superposed and thus the information image is inconspicuous even when the transparent toner image is superposed thereon.

However, in this embodiment, the information image is not the model number pattern but is low visibility bar codes (LVBC) as described in JP-A 2008-271110.

The LVBC can realize data embedded in a sufficient amount of information compared with the model number pattern in Embodiment 1 and the add-on lines in Embodiment 3. Further, the embedded information can be extracted later as digital information. Further, during copying, the LVBC is resistant to some extent to factors, which prevent the information extraction, such as rotation, scaling and partial deletion of the original image, distortion of the signal by copying, or contamination of the original. Further, in order to prevent copying a copy-inhibited original, the LVBC has a real-time property such that it can be extracted during the copying or has a high-speed property following the real-time property.

The general structure and control of the image forming apparatus 100, the detection of the superposition of the transparent toner image on the color toner image, the setting of the input signal values din A and din B with respect to the information image depending on the presence or absence of the superposition, and the like are similarly to those in Embodiment 1, thus being omitted from description.

As shown in FIG. 13(a), many LVBC are embedded over the whole image forming surface of a print output product. In addition to an image originally formed on the print output product, many LVBC embedded randomly at first glance are in sight. In each of dots of the LVBC, the numerical value data as the added information is embedded. The added information is divided into two types of information areas different in characteristic depending on a manner of use.

As shown in FIG. 13(b), a first area 2901 includes information indicating copy inhibition and stores information to be extracted at high speed and utilized during copying using the image reading portion 102. The extraction processing of the copy inhibition information is always carried out when any original is copied, so that delay of the extraction processing influences a whole copying speed. Therefore, an analyzing speed comparable to a speed of scanning processing of the image reading portion 102 is required.

The first area 2901 includes small square areas which are periodically embedded in a large square area as a second area 2902. In each of the small square areas, the same information is stored. The first area 2901 is repetitively embedded, so that redundancy is increased and thus reliability with respect to noise and error is improved.

In the second area 2902, tracking information is embedded. The tracking information is stored as copy history in the image forming apparatus 100 and is subjected to the extraction processing when the analyzing processing is carried out by an administrator during discovery of leakage of information. For this reason, there is no need to extract the tracking information during a normal copying operation. Thus, the extraction processing does not influence on the whole copying speed even when the real-time property is not ensured, so that a lowering in speed to some extent is allowed.

The information embedded as the tracking information includes a personal name or an organization name of original preparer, a source address of a print job, MAC address, installation location, printing date, and printing time, so that a data size is large.

Also in the second area 2902, the same square area is periodically embedded similarly. In the first area 2901, the embedded information of the second area 2902 is not written, so that the writing is made exclusively. The first area 2901 has a length 2903 and is formed at an interval 2904. The second area 2902 has a length 2905.

With respect to the LVBC, the dot pattern which is called grid is printed in order to embed the added information.

As shown in FIG. 13(c), at each of intersections of vertical and horizontal phantom lines 3901, a dot centroid 3902 is disposed to constitute the grid. With each dot centroid 3902 as the center, dot positions 0 to 7 are set and 3-bit numerical value data are associated with the dot positions 0 to 7, respectively, so that one dot 3903 is disposed at each of the dot positions.

Therefore, the grip itself is a group of dots which are equidistantly spaced in vertical and horizontal directions. When minimum distances between adjacent dots are drawn by phantom lines (guide lines), a phantom lattice pattern consisting of stripes extending in vertical and horizontal directions with regular intervals appears. The added information is embedded in the dots disposed on the grid by being displaced in 8 directions including the vertical and horizontal directions. The dot is not disposed at the dot centroid 3902. Actually, the dot 3903 is displaced and disposed at a position spaced from the dot centroid 3902.

For example, in the case where binary information “010111110011” is embedded, “010111110011” is divided very three-bit into four pieces of information “010”, “111”, “110” and “011”. Each three-bit is subjected to decimal conversion to obtain 2, 7, 6 and 3. The dots constituting the grid are displaced and disposed at the positions of 2, 7, 6 and 3, respectively, as shown in FIG. 11(c). By repeating this processing, with respect to the LVBC, it is possible to embed the added information of about 2,000 bites. Further, by periodically repeating the embedding of the added information, redundancy can be increased to improve reliability with respect to misrecognition as the (picture) image, and contamination, creases and partial breakage of the sheet.

### Embodiment 5

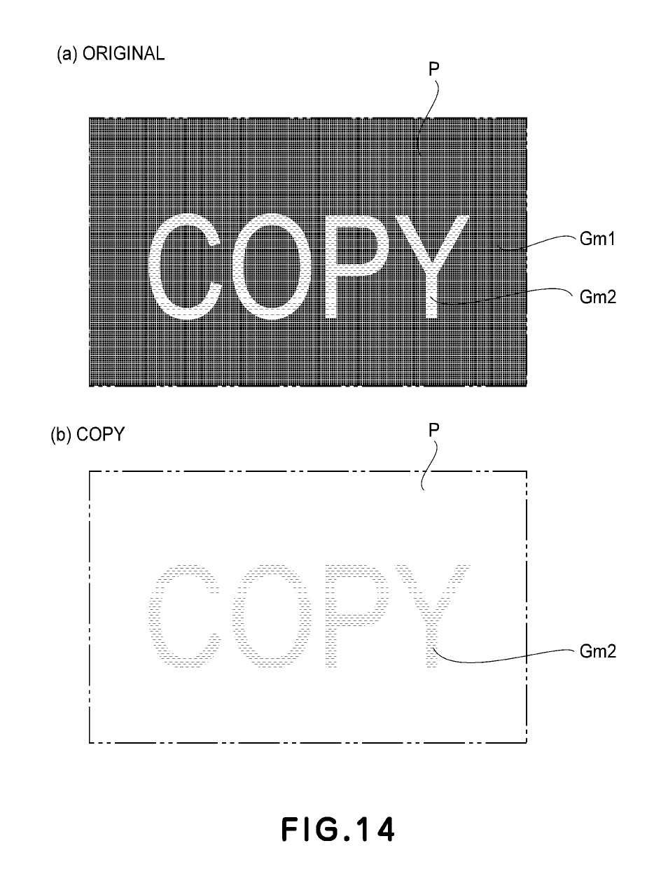

FIGS. 14(a) and 14(b) are schematic views for illustrating the forgery-preventing image in this embodiment. In this embodiment, in the image forming apparatus 100, the forgery-preventing image is printed on the recording material at the white background portion of the image by using a halftone image so as not to be conspicuous. The forgery-preventing image is the halftone image, with a uniform image density, which is different from the information image in Embodiment 1 but when the transparent toner image is superposed thereon, the apparent density differs between the portion where the transparent toner image is superposed and the portion where the transparent toner image is not superposed. For this reason, the portion where the transparent toner image is superposed, compared with the portion where the transparent toner image is not superposed, is in sight as the halftone image with a high density. As a result, the whole image is not a uniform halftone image, so that the portion where the transparent toner image is superposed is conspicuous.

In this embodiment, similarly as in Embodiment 1, the toner amount is made different between the forgery-preventing image on which the transparent toner image is superposed and the forgery-preventing image on which the transparent toner image is not superposed, so that the whole forgery-preventing image is made in sight with a uniform density.

The general structure and control of the image forming apparatus 100, the detection of the superposition of the transparent toner image on the color toner image, the setting of the input signal values din A and din B with respect to the information image depending on the presence or absence of the superposition, and the like are similarly to those in Embodiment 1, thus being omitted from description.

When a forgery-preventing image mode is set, the image forming apparatus 100 shown in FIG. 1 outputs halftone forgery-preventing images Gm1 and Gm2 at the white background portion of the image formed on the recording material P by using a black toner image as shown in FIG. 14(a).

The forgery-preventing image Gm1 is formed by using dots each having a size which is neglected as a noise point by the reader image processing portion 209.

The forgery-preventing image Gm2 is formed inside outlines of a massage “COPY” by using dots each having a size which is read as an isolated point by the reader image processing portion 209.

The forgery-preventing images Gm1 and Gm2 are formed with the dots different in size but have the same apparent density gradation level by changing the dot density. The forgery-preventing image Gm1 is formed at the dot density higher than that of the forgery-preventing image Gm2, so that the forgery-preventing images Gm1 and Gm2 are formed at the same apparent halftone density.

When the thus formed original image is copied by the image forming apparatus 100, as shown in FIG. 14(b), only the forgery-preventing image Gm2 is copied since the image reading portion 102 does not read the Gm1. As a result, the massage “COPY” formed by a low-resolution forgery-preventing image appears.

Further, with respect to the forgery-preventing images Gm1 and Gm2, when the transparent toner image is superposed as shown in FIG. 4(c), the density difference is observed between the portion where the transparent toner image is superposed and the portion where the transparent toner image is not superposed to impair uniformity of the halftone image, so that the image quality of the forgery-preventing image is lowered. That is, the apparent density is increased, so that the forgery-preventing image is conspicuous and the brightness of the image surface is lowered.

For this reason, similarly as in Embodiment 1, there is a need to extract the area in which the transparent toner image is superposed and form the forgery-preventing image decreased in toner amount in the area.

Incidentally, the forgery-preventing images Gm1 and Gm2 may be formed not only by changing the dot size but also by changing a thickness of mesh pattern lines subjected to area gradation modulation as described in JP-A 2007-81750.

As described above, by the superposition of the transparent toner image, there arises a problem that the forgery-preventing image which appears by copying and the image, which is to be originally concealed, such as the tracking information for identifying the image forming apparatus which has outputted the print are conspicuous. Incidentally, with respect to the image data which is to be originally concealed, in the case where a mode in which the image which is not originally intended to become conspicuous is covered with the transparent toner is selected, the LUT used for forming the image to be concealed is switched. Specifically, the image forming apparatus is provided with a control means for controlling the toner amount per unit area so as to be smaller in the case where the image is coated with the transparent toner than the case where the image is not coated with the transparent toner.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 253357/2009 filed Nov. 4, 2009, which is hereby incorporated by reference.

What is claimed is:

1. An image forming apparatus comprising:
a photosensitive member;
an exposure device for exposing to light said photosensitive member to form an electrostatic latent image by using exposure image data for an output image to which an information image to be formed so as to be made difficult to be visually recognized with respect to background color has been added;
developing means for developing the electrostatic latent image with color toner into a color toner image;
transparent toner image forming means for forming a transparent toner image located on the color image on a recording material; and
image processing means for generating the exposure image data so that a toner amount of the information image on which the transparent toner image is superposed is less than that of the information image on which the transparent toner image is not superposed.

2. An apparatus according to claim 1, wherein said image forming apparatus is operable in a whole surface transparent image mode in which the transparent toner image is superposed on a whole area of the color toner image and is outputted, and
wherein said image processing means generates, when the whole surface transparent image mode is selected, the exposure image data so that the toner amount of the information image is less than that of the information image when the whole surface transparent image mode is not selected.

3. An apparatus according to claim 1, wherein said image forming apparatus is operable in a partial transparent image mode in which the transparent toner image is partly superposed on the color toner image and is outputted, and
wherein said image processing means generates, when the partial transparent image mode is selected, the exposure image data so that the toner amount of the information image at a portion where the transparent toner image is superposed is less than that of the information image at a portion where the transparent toner image is not superposed.

4. An apparatus according to claim 1, wherein the information image is formed at a white background portion, where the color toner image is not superposed on the information image, by using yellow toner.

5. An image forming apparatus comprising:
a photosensitive member;
an exposure device for exposing to light said photosensitive member to form an electrostatic latent image by using exposure image data for an output image to which a forgery-preventing image to be wholly visually recognized at a uniform density even when a dot size is partly changed has been added;
developing means for developing the electrostatic latent image with color toner into a color toner image;
transparent toner image forming means for forming a transparent toner image located on the color image on a recording material; and
image processing means for generating the exposure image data so that a toner amount of the forgery-preventing image on which the transparent toner image is superposed is less than that of the forgery-preventing image on which the transparent toner image is not superposed.

6. An image forming apparatus comprising:
a photosensitive member;
an exposure device for exposing to light said photosensitive member to form an electrostatic latent image by using exposure image data for an output image to which an information image to be formed so as to be made difficult to be visually recognized with respect to background color has been added;
developing means for developing the electrostatic latent image with color toner into a color toner image;
transparent toner image forming means for forming a transparent toner image located on the color image on a recording material;
selecting means for selecting a mode from a plurality of modes including a transparent image mode in which the transparent toner image is superposed on a whole area of the color toner image and is outputted and a color image mode in which only the color toner image is outputted without forming the transparent toner image on the recording material;
image processing means for generating the exposure image data so that a toner amount of the information image when the transparent image mode is selected is less than that of the information image when the color image in which is selected.
